(19) United States
(12) Patent Application Publication
(10) Pub. No.: US 2024/0330273 A1
(43) Pub. Date: Oct. 3, 2024

(54) BACKWARD COMPATIBLE AND SCALABLE HETEROGENEOUS DATABASE SYSTEM

(71) Applicant: Goldman Sachs & Co. LLC, New York, NY (US)

(72) Inventors: Alok Madhukar, Hyderabad (IN); Rahul Nandkumar Bindu, Hyderabad (IN); Somnath Khanra, Hyderabad (IN); Ashish Gupta, Hyderabad (IN); Nitish Gupta, Uttar Pradesh (IN); Himanshu Pandey, Bengaluru (IN); Erik Funkhouser, Dallas, TX (US)

(21) Appl. No.: 18/620,064

(22) Filed: Mar. 28, 2024

(30) Foreign Application Priority Data
Mar. 31, 2023 (IN) 202311024718

(51) Int. Cl. G06F 16/23

(52) U.S. Cl. CPC G06F 16/2379

(57) ABSTRACT

A heterogeneous database system allows users to interact with multiple databases. The heterogeneous database system uses a middleware that receives client request and processes them using the databases supported in the backend. The heterogeneous database system presents a uniform interface, for example, APIs to access multiple database that may have different architectures or may be provided by different vendors. The databases connected to the middleware in the backend may include relational databases, document databases, key-value stores, and so on. The middleware stores transaction logs that represent transactions across the multiple databases supported. The heterogeneous database system provides scalability as well as backward compatibility by supporting legacy database systems as backend databases while allowing newer database architectures to be added.

### CROSS-REFERENCE TO RELATED APPLICATION

This application claims the benefit of Indian Provisional Application No. 202311024718, filed on Mar. 31, 2023, which is hereby incorporated by reference in its entirety.

### FIELD OF ART

The disclosure relates to databases in general and more specifically to a backward compatible and scalable database system based on a middleware that connects to multiple databases.

### BACKGROUND

An organization typically stores data in a database, for example, user information, information describing different types of objects, information describing activities such as online transactions performed by an online system, data streams, logs representing events associated with systems of the organization, and so on. An organization may develop specific functionality based on the database, for example, specific customized features, specific application programming interface (APIs) used by applications of the organization, and so on. However, to scale the system over time, an organization may have to use other types of databases, for example, database offered by other vendors. However, switching to a different database is challenging since the other database may not offer all the functionality that was developed for the current database being used by the organization.

### SUMMARY

A heterogeneous database system processes transaction log queries that process information stored in transaction logs representing transactions of a plurality of backend databases. The plurality of backend databases may comprise databases having different databases architectures, for example, a relational database and a key-value store. The heterogeneous database system creates database connections with each of the plurality of databases.

A database middleware component of the heterogeneous database system repeats the following steps. The database middleware component receives a request for a database operation from a client device. The database operation can be an insert operation, an update operation, a delete operation, or an append operation. The database middleware component stores a record comprising information describing a transaction log for the database operation of the request in a transaction log store. The database middleware component identifies a target database from the plurality of databases for performing the database operation of the request. The database middleware component directs the request to the target database for execution. These steps are repeated for multiple requests received by the database middleware component.

The heterogeneous database system receives a transaction log query aggregating information over a plurality of database operations performed by the system. The plurality of database operations includes database operations performed by the relational database and database operations performed by the key-value store. The database middleware component executes the transaction log query using the transaction log store of the database middleware component and provides the result of execution of the transaction log query based on the execution.

According to an embodiment, the heterogeneous database system monitors performance of each of the plurality of databases for requests processed by the heterogeneous database system and selects the target database for directing the request for execution based on the monitored performance.

According to an embodiment, the heterogeneous database system maps characteristics of the database operations specified in the requests processed by the heterogeneous database system to performance of each of the plurality of databases. The selection of the target database for directing the request for execution is based on the monitored performance comprises, determining characteristics of the request and selecting the target database based on the mapping.

According to an embodiment, the heterogeneous database system trains a machine learning based model configured to receive as input, features describing requests processed by the heterogeneous database system and predicting resource requirements of the heterogeneous database system. The heterogeneous database system executes the machine learning based model to predict resource requirements the heterogeneous database system.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 shows the overall environment in which the system operates according to an embodiment.

FIG. 2 shows the system architecture of the database middleware according to an embodiment.

FIG. 3 illustrates the system's data flow and functional use cases according to an embodiment.

FIG. 4 is a flowchart illustrating the processing of transaction logs for supporting analytical queries based on transactions processed by the heterogeneous database system 100, according to an embodiment.

FIG. 5 is a flowchart illustrating the processing of transaction log queries by the heterogeneous database system 100, according to an embodiment.

FIG. 6 shows a flowchart illustrating the process of training a machine learning based model for predicting resource usage in a heterogeneous database system 100, according to an embodiment.

FIG. 7 shows a flowchart illustrating the process of deploying and executing the machine learning based model for predicting resource usage in a heterogeneous database system 100, according to an embodiment.

FIG. 8 is a block diagram illustrating components of an example machine able to read instructions from a machine-readable medium and execute them in a processor.

Embodiments of the invention include methods described herein, a non-transitory computer readable storage medium storing instructions for performing steps of the methods disclosed herein, and systems comprising processors and computer readable non-transitory storage medium to perform steps of the methods disclosed herein.

The features and advantages described in the specification are not all inclusive and in particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the disclosed subject matter.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### DETAILED DESCRIPTION

A system according to various embodiments uses a database for storing data processed by various applications. The users of such a system may include various groups (e.g., departments) within an organization. Over time, the storage requirements of various groups using the database grow. A particular database architecture may impose size limits on the amount of data stored. As a result, the users of the database, e.g., various groups within the organization are restricted by the current system's limitations related to data storage. Users may want to increase their business, thereby increasing the amount of data stored without being concerned about capacity of underlying infrastructure. Furthermore, developers want to be able to work on not just proprietary technologies but also some of the latest modern technologies in the industry.

The system allows users to onboard more tenants smoothly and thereby increase their operations without worrying about underlying infrastructure. The system allows users and developers to leverage advancement in the technology and provide most appropriate and cost-effective solutions. The system ensures that existing users do not observe any adverse impact to performance. Accordingly, system is backward compatible in terms of feature sets as well as from performance benchmarking perspective. The system allows different technologies such as different database architectures to be easily integrated.

The system according to an embodiment allows scaling of the source database system using heterogenous databases. The system architecture scales the underlying database storage by adding new databases that may have a database architecture different from the current database architecture. Users are able to seamlessly query the underlying databases.

The system according to an embodiment enhances database persistence using long term transaction logs. The system implements transaction log interface that allows logging data in addition to logs generated by the underlying system. This allows system to persist longer than the underlying database, thereby supporting longer term recovery and reconstruction of database.

The system according to an embodiment presents a database interface based on a database architecture that is distinct from the underlying database architecture being used by the backend. For example, the underlying database architecture may be key-value store based but the system presents an interface of relational databases.

The existing database is referred to herein as a source database system. The system provides a solution that is backward compatible and at the same time allows users to be agnostic of the backend, allows developers to use tools of their choice, allows latest database technologies to be plugged into the system based on best fit for a given use case. The system comprises a middleware that represents features supported by the source database system and provides an API that helps users and developers to connect and operate the system just as they use the source database system, provides options for new tools and allows different backend database architectures to be integrated.

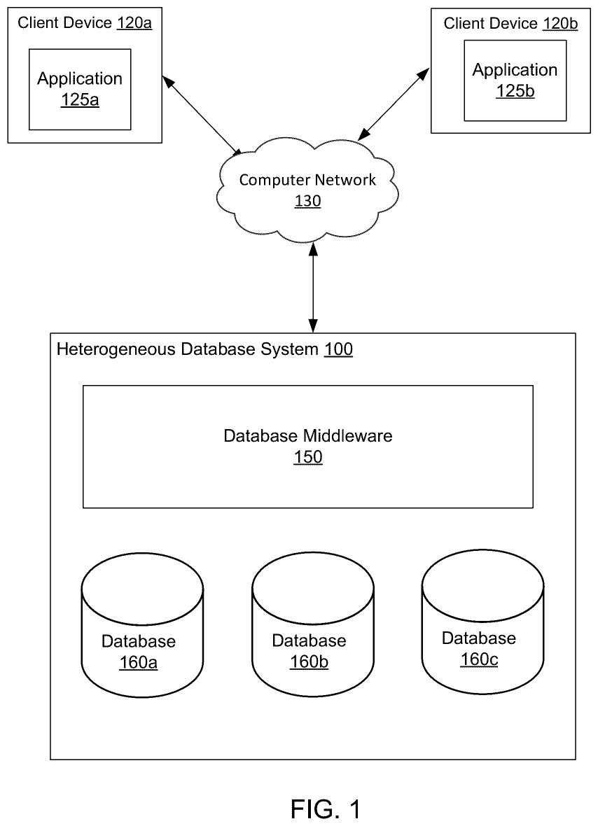

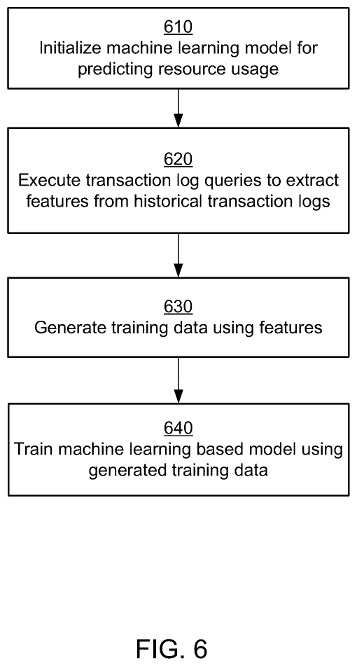

FIG. 1 shows the overall environment in which the system operates according to an embodiment. The overall system environment includes a heterogeneous database system 100, one or more client devices 120, and network 130. FIG. 1 illustrates the heterogeneous database system 100 as an online system that represents a computing system that is connected to other systems via a computer network and can communicate with the other systems via the computer network. Although embodiments are described by illustrating the heterogeneous database system 100 as an online system, certain techniques disclosed are not limited to online systems and can be performed by any system that may or may not be connected to other systems via computer networks. For example, the training of machine learning models illustrated in FIG. 6 and described in connection with FIG. 6 may be performing using an offline process. In other embodiments, more or fewer components than those indicated in FIG. 1 may be used. For example, there may be more or fewer instances of client devices 120 shown in FIG. 1.

The database middleware 150 handles various operations related to the heterogeneous database system, for example, multi-primary writes, support for big transaction sizes, support for multi-record transactions, contiguous monotonically increasing transaction IDs, and so on. The database middleware 150 may also be referred to herein as the middleware, the middleware component or the middleware layer.

The database middleware 150 provides an interface for database connection and a common message protocol for data storage and retrieval, which is agnostic of the underlying storage technology. The system provides implementation to an expandable set of user queries. The middleware also provides an abstract interface which can be implemented for heterogeneous storage/database technologies. Contract between users and the system is upheld regardless of how and where the data is stored. Operations and administration are important functions of any database management systems. Middleware also provides a common interface and operational APIs for maintenance and admin controls. Operational APIs too are agnostic of the underlying database implementation.

The database middleware 150 can be configured to store frequently accessible data and metadata in any in-memory database, while infrequently used data can be stored to disk or cloud. For several organizations, old data is important, for example, in a financial firm, where the old trade details are often referred for auditing purpose and to create new strategies. Users run periodic jobs to copy the data to archive storages. With database middleware 150, the task of archiving and querying the archived data becomes an easy. The database middleware 150 can be configured to move data satisfying certain criteria from in-memory/disk to a reliable cloud storage. The database middleware 150 can distinguish when a user is querying archived data. It can directly connect and read the data from cloud.

In-memory database stores often put restrictions on the size of an object that can be stored in the database. The database middleware 150 provides the flexibility to adopt a hybrid approach where large objects can be stored on an S3 instance/Disk with a link to the same inserted into the in-memory or on-prem store, thus reducing the restrictions on object size. Users can focus on building solutions rather than on storage and operational aspects.

A transaction is a series of operation on objects, which succeeds or fails together. Transaction logs can be used for integrity check during disaster recovery, rebuilding a database or can be used for book-keeping and auditing. Transaction logs are write ahead logs, which means that the changes are first recorded in the log, i.e., a persistent storage before the changes are written to the database.

A non-scalable existing storage for transaction logs can be scaled using always available and resilient distributed storage using a middleware. This does not involve copying or moving existing transaction logs to a different database. A different storage can be plugged in alongside older storage, thus providing the ability to query both databases without needing to migrate existing data.

The databases 160a, 160b, 160c store data and each database may have a different architecture. A database 160 may also be referred to herein as a backend database. For example, one database 160a may be a key-value based document store such as RocksDB™ whereas another database 160b may be a relational database such as Oracle™ or IBMs DB2™. Two different databases 160 may be different versions of the same database architecture or may be provided by different vendors. Accordingly, even if two databases have same architecture, their specific features or interfaces provided by the databases may be different. The heterogeneous database system 100 provides a uniform and consistent interface to the users, for example, the applications 125a, 125b running on the client devices 120a, 120b respectively. For example, the heterogeneous database system 100 allows all databases 160 to be accessed as key-value stores independent of their database architectures. Alternatively, the heterogeneous database system 100 may allow all databases 160 to be accessed as relational databases independent of their database architectures.

The heterogeneous database system 100 may be hosted on one or more computing systems, each computing system including one or more processors, memory, secondary storage and input/output controller. Each computing system used for hosting the components of the heterogeneous database system 100 is typically a server class system that uses powerful processors, large memory, and fast input/output systems compared to a typical computing system used, for example, as a client device 120.

The client devices 120 represent various systems that interact with the heterogeneous database system 100 via the network 130. These devices may represent servers, routers, storage devices, and so on. One or more devices may be attached to peripheral devices, such as printers. The devices communicate with each other via the computer network 130. The computer network 130 may comprise any combination of local area and/or wide area networks, using both wired and/or wireless communication systems. In one embodiment, the network uses standard communications technologies and/or protocols. In another embodiment, the components of the system environment can use custom and/or dedicated data communications technologies instead of, or in addition to, the ones described above.

FIG. 1 and the other figures use like reference numerals to identify like elements. A letter after a reference numeral, such as “120a,” indicates that the text refers specifically to the element having that particular reference numeral. A reference numeral in the text without a following letter, such as “120,” refers to any or all of the elements in the figures bearing that reference numeral (e.g. “120” in the text refers to reference numerals “120a” and/or “120b” in the figures).

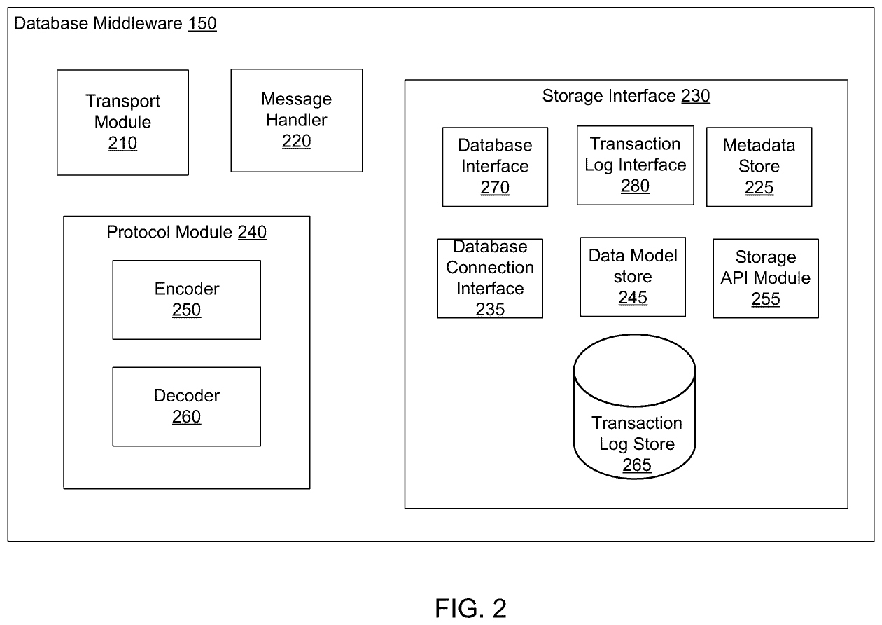

FIG. 2 shows the system architecture of the database middleware 150 according to an embodiment. The database middleware 150 includes a transport module 210, a message handler 220, a protocol module 240, and a storage interface 230. The protocol module 240 includes an encoder 250 and a decoder 260. The storage interface 230 includes a database interface 270, a transaction log interface 280, a metadata store 225, a database connection interface 235, a data model store 245, a storage API module 255, and a transaction log store 265. Other embodiment may include more or fewer modules than those indicated herein.

The transport module 210 is a client's entry point into the middleware. The transport module 210 support various features including, providing network communication and load distribution among worker contexts/threads, providing ability to write cross-platform networking code, working on the most of existing platforms-Windows, Unix-like, etc. According to various embodiments, the transport module 210 supports both IPv4 and IPv6, provides support for TCP & UDP, provides support for asynchronous operations, provides support for SSL connections, provides support for delayed operations using timers, and so on.

The above set of features supported by transport module 210 make the middleware agnostic to the type of network protocol between client and server. The clients may use TCP protocol to communicate with the server or UDP or any other protocol. The middleware can serve the clients independent of the underlying communication protocol used.

The protocol module 240 implements communication protocols such as the following. The protocol module 240 allows the database middleware 150 to communicates with the client by sending and accepting byte streams containing data serialized in accordance with a predefined protocol. The middleware includes encoders and decoders that can serialize and deserialize the byte stream to classes implemented in a particular programming language such as C++ or Java and vice-versa. This is done via a ToRequest and ToStream APIs. The ToRequest API decodes the incoming byte stream to the logical message implementation and the ToStream API serializes the server response to the byte stream that is sent back to the client. These protocol-layer APIs provide a simple interface which is customizable and pluggable, making way for the middleware to support various protocols, such as gRPC.

According to an embodiment an encoder 250 and a decoder 260 in the protocol module 240 serialize and de-serialize messages. An example layout of messages includes information such as message size, message type, and the payload of the message. The layout of messages can change in accordance with how the protocol is designed. The decode and encode functions can be extended to plug in custom protocols.

The message handler 220 acts as the processing unit of the database middleware 150. The message handler 220 converts decoded messages to requests and forwards them. The message handler 220 takes action based on the message type. The message handler 220 invokes storage interface 230 to perform read/write operations on the underlying databases. The message handler 220 forms response and sends the response to the client. The message handler is customizable and can grow and shrink on the basis of number of messages supported.

Storage interface 230 serves as a gateway to vendor provided storage solutions. The storage interface 230 provides customizability over the storage. The storage interface 230 enables a storage-agnostic persistence in the middleware. The Message Handler module invokes the storage interface to access the database.

The metadata store 225 to store the information describing the storage configuration of underlying database. Users can configure various parameter for different database. A user can also specify where a particular type of data can be stored. For example, frequently accessed data stored in in-memory database and archives to be stored on cloud.

The database connection interface 235 that supports APIs to connect to various databases 160. The APIs include open connection, close connection, configure database, etc. This interface makes use of the user provided configuration from metadata store to open and configure a database.

The data model store 245 for storing data in different types of databases. Middleware defines a model and translates data to a format understood by the underlying database implementation while storing. For example, the format of a key-value store may be different from format of data stored in a relational database. The data model describes the format of the data stored in each database and allows transformation from one format to another. While retrieving, the data is converted back to the format understood to the client.

The storage API module 255 supporting APIs for providing common interface for client queries. Queries are mapped to corresponding API calls of underlying database implementation. The storage interface 230 also provides a set of common APIs for operation and maintenance purpose. These operational APIs maps to database specific APIs and are implemented in the middleware.

The database interface 270 encapsulates the database calls (APIs/Queries supported by the underlying database 160) and exposes generic APIs for read & write. For example, when a client sends a transaction write request to the middleware, the message handler 220 generates series of generic database operation (e.g., reads & writes) for the database interface 270. The database interface 270 translates the generic database operations, into the format expected by the underlying database 160, and performs the database calls, i.e., APIs/Queries supported by the underlying database 160. Different storage interface 230 may be provided for different storage options. This allows the users to plug in technologies catering to the specific use cases while being backward compatible.

According to an embodiment, the storage interface 230 is configured to interface with multiple storage systems, each possibly supporting a different interface due to differences in architectures, vendors, versions, and so on. The middleware 150 may direct the storage of a requested object to (1) both in-memory store and/or persistent database technologies (2) a combination of both on-premise solutions like RocksDB and on-cloud solutions such as Aurora and Spanner. The storage interface 230 allows development of new applications and tools and allows different backend technologies to be integrated with the client applications.

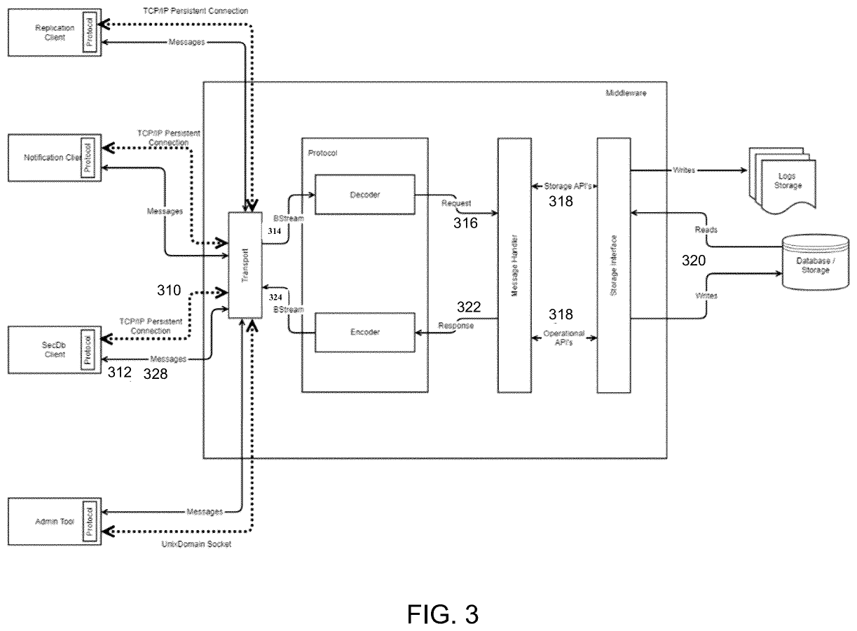

The transaction log interface 280 serves as a gateway to storage systems to which transaction logs are written and stored. A transaction is a series of operation on objects, which succeeds or fails together. Transaction Logs can be used for integrity check during disaster recovery, rebuilding a database or can be used for book-keeping and auditing. Transaction logs are write ahead logs, i.e., the changes are first recorded in the log (i.e. persistent storage) before the changes are written to the database. Log Interface provides APIs to store data in a transaction log store 265. The transaction log store 265 may be a relational database. FIG. 2 shows the transaction log store 265 as a component of the storage interface 230 that is available locally in the database middleware 150. However, in other embodiments, the transaction log store 265 may be available in an external system, for example, as illustrated in FIG. 3.

A transaction is a series of operation on objects, which succeeds or fails together. A transaction log is a history of actions executed to guarantee ACID properties over crashes or hardware failures Physically, a transaction log is a file listing changes to the database, stored in a stable storage format. Many relational databases such as MySQL, DB2, etc. have transaction logs and use them for disaster recovery and to enhance durability properties. Most of these databases use disk for transaction log storage and have predefined parameters for size and time-to-live. Querying the changes made in a particular transaction also becomes a challenge.

For certain application such as financial applications, transaction logs are not only used for integrity check during disaster recovery or rebuilding a database, they are also used for book-keeping and auditing purpose. Persistence of these transaction logs for longer term and in a scalable way becomes a necessity. The transaction log interface 280 allows persisting the transaction logs for periods of time longer than supported by a underlying database 160. Accordingly, if an underlying database 160 has deleted the logs for a particular period, for example, a time interval older than a threshold and the transaction logs are needed for reconstruction of the data, the heterogeneous database system 100 obtains the required data for that particular time interval from the transaction log interface 280.

The database middleware 150 provides a highly scalable and highly available transaction log storage. Usually database technologies save logs on disk which ends up being single point of failure. By design the transaction log interface 280 is backend agnostic. This allows the system to horizontally scale the storage by using highly available and scalable service like AWS S3 etc. This means negligible downtime for service that depend on transaction logs for performing their day-to-day activities.

Accordingly, transaction log interface 280 acts as a long term transaction logs persistence system. For a trading database, transaction logs serve as source of truth. Transactions Logs are sometimes kept for longer duration to meet the regulatory and audit requirement. This means that decades old transaction logs are required to be made available and would have seen many software updates. Every software update could choose to modify the format in which transaction logs are persisted. The transaction log interface 280 of the database middleware 150 can be leveraged to continue reading the transaction logs data stored in the legacy format. Additionally, the database middleware 150 has potential to bring in innovations like using a different storage technology (potentially distributed), that is, much of this will have to be powered by the database middleware's 150 ability to read multiple log format and perform a merge across those. This ability reduces the need of maintaining duplicative infrastructure for storing antiquated transaction logs.

The transaction log interface 280 provides a common protocol for storage and retrieval (logs serialization and deserialization), which is agnostic of the underlying storage technology. The transaction log interface 280 is designed to be storage agnostic. Accordingly, logs can be stored on disk or on cloud (AWS S3) or any other storage service. The transaction log interface 280 allows storage of the logs in a heterogeneous way, i.e., partially on disk and partially on cloud.

On write request from a client, the message handler 220 invokes a series of events namely transaction validation, transaction logging and transaction applying. Once a transaction is validated against existing data, it is logged before actual object is modified in the database. This guarantees that changes are saved in case of a failure. According to an embodiment, the transaction log interface 280 includes the following components: (1) a transaction log metadata store that holds the information about the storage configuration of underlying database. Database administrators can configure various parameter for different database. A database administrator can also specify where the transactions need to be logged. (2) a transaction log connection interface that includes APIs to connect to the log storage. Some APIs include Open, Close, Configure, etc. This interface makes use of the user provided configuration from metadata store to open and configure the log storage. (2) Log Encoder & Decoder for translating data to and from a serialized format. Data may be stored in raw files as bytes streams and a model used for determining how to transform the data.

The heterogeneous database system 100 is agnostic to the type of backend database. Underlying database can have its own transaction logging mechanism. The transaction log interface 280 allows logging transactions in addition to logs generated by the underlying system. This allows system to persist transactions longer than the underlying database in a scalable way, thereby supporting longer term recovery and reconstruction of database. Furthermore, the Transaction Log Interface provide APIs to read/query the transaction logs at any given point of time.

A typical transaction may include one or more database operations including inserts, updates, or deletes. The transaction log interface 280 maintains the granularity of each transaction while logging it to a file. This helps is identifying the exact mutation while replaying the logs or recovery or auditing.

The transaction log interface 280 also provides a set of common APIs for operation and maintenance purpose. These APIs are used of disaster recovery and integrity check. The transaction log interface 280 provides APIs for seeking and reading transaction logs at any given point of time. This is useful for auditing historical data.

FIG. 3 illustrates the system's data flow and functional use cases according to an embodiment. Dataflow remains same for other areas of application.

A typical client request is processed as follows. In step 310, the heterogeneous database system 100 receives a client connection request. In step 312, the middleware 150 authenticates the request and establishes connection with the client. In step 314, the handshake, exchange of other messages takes place. Each message is received by the transport layer as a byte stream and then fed into the decoder. In step 316, the decoder translates the byte stream into request objects and invokes the message handler sequence for that particular request. In step 318, following that APIs to the storage interface are called and the write/read interaction takes place with the user defined datastore option. In step 320, read/write happens on the storage. For writes transaction logs are written onto the user defined storage type. In step 322, the message handler forms the response. In step 324, the response is encoded to a byte stream and handed over to the transport. In step 328, the byte stream response is sent to the client.

Some clients may have their own protocol, handler and storage implementation. For example, an administration client supports administration tools that provide utilities to control the current state of the database and perform routine management tasks like taking a backup/checksum/purging old logs/data and get reports from the database. A replication client implements a globally replicated database which is eventually consistent. A replication service, is used to replicate the transactions/data to other databases. The middleware provides highspeed streaming service for transactions to reduce creation of conflicts. A notification client provides ability to register interest for update on certain objects for interest. The client is notified as soon as there are update on the database.

### Transaction Log Queries

As compared to a key-value or any non-relational data store, relational databases provide capability to run complex queries on the data. Hence the data is required to be streamed out from KV Store to a Relational Store. Using database middleware's 150 transaction log interface 280, transaction log data is directly stored in relational form along with current serialized key value bytes, providing services like log readers to directly consume data from a relational persistent log storage. This gives more flexibility on how transaction logs are queries, for example, to perform data analytics which is difficult with blobs of data stored as key value.

According to an embodiment, the transaction log store 265 stores transaction log data using one or more relational database tables. For example, a transaction_data table stores metadata describing each transaction are as follows:
TRANS_ID|TRANS_TIMESTAMP|TRANS_COMMIT_STR|APPLICATION_NAME|USER_NAME|IP_ADDRESS|PARTS_COUNT|SIZE_BYTES

Accordingly the transaction_data table stores information describing a transaction including, a transaction identifier, a transaction type, a transaction timestamp, a transaction commit status stored as a string, an application name of the application that sent the request for the transaction, a user name of the user associated with the transaction request, an IP (internet protocol) address of the client device from which the transaction request was received, a parts count indicating how many data objects store the data associated with the transaction, and a size in terms of number of bytes of data of the objects processed by the transaction.

The details of objects processed by the transaction are stored in a transaction_part_data table that stores information describing a transaction as follows:
TRANS_ID|PART_NUMBER|TRANS_TYPE|OBJECT_NAME|PART_BLOB

Accordingly, the transaction_part_data table stores information describing a transaction including a transaction identifier of the transaction, a part number of the transaction part, a transaction type, an object name, and a representation of the object, for example, a binary large object (BLOB). The two relational tables can be joined to perform various transaction log queries.

The transaction log store 265 can be used to perform a flow rate query that determines a rate of transactions, i.e., an estimated number of transactions in a unit time. The transaction rate may be determined for a particular database 160 or for a subset of the databases 160 connected to the database middleware 150. Such transaction log queries help identify high transaction volume periods and allow determining whether one or more databases 160 can support that kind of transaction flow rate in case the transaction flow rate further increase in future. For example, during the index rebalances certain databases such as financial databases are under increased load. If transaction flow rate increases beyond certain threshold, clients experience higher write-latency, thereby providing poor user experience. The heterogeneous database system 100 allows such queries to be made to analyze the flow rate of transactions so that capacity planning may be performed, or data objects are properly distributed as they arrive across multiple databases so as to balance out the load across the multiple databases 160.

Using such transaction log queries, users such as database administrators (DBA) can periodically query the transaction log store 265 and detect any gradual increase in size of the database or changes in transaction flow rate. This allows DBAs to detect early, any pattern in the transaction flow that might lead to a particular database 160 getting full or reaching processing capacity. The transaction log queries can aggregate transaction information across various attributes such as aggregate transaction flow from a particular application or a set of applications, aggregate transaction flow from a particular user or a set of users, aggregate transaction flow from a particular client device or a set of client devices, aggregate transaction flow from a particular IP address or a set of IP addresses, aggregate transaction flow during a particular time interval, as well as combinations of these attributes, for example, transaction flow rate from a set of applications during a particular time interval. Storing transaction logs in a relational database provides the system to run such database queries or analytic queries and user the results for capacity planning of the heterogeneous database system 100 including capacity of the backend databases 160 connected to the database middleware 150 or capacity of resources such as memory resources, or networking resources used by the heterogeneous database system 100.

Transaction log queries can be used for various applications such as: (1) Production Support: Transaction log queries allow users to find a full history of an object (using Transaction_Part_Data table). For example, occasionally, business processes give unexpected result, that may be caused by a database-object having incorrect value. Ability to view modification history of such object enables root cause analysis of abnormal patterns in data and helps quick remediation. (2) Ad hoc Analytics: Transaction log queries support ad hoc analytics, i.e., analysis that may not be supported by a data-source. For example, transaction log queries may be executed to determine whether certain type of object was created and deleted within a threshold time interval, e.g., a week. (3) Stop-Gap Transaction Activity Monitoring: In absence of strategic data-source for transaction-monitoring, such data-source may provide stop-gap monitoring. For example, such database can power queries to detect unusual transactional activity, for example, trading activity in financial systems. An example of unusual transactions activity includes a client creating order and sending request to cancel the order immediately or moving the price in a trade. The database middleware 150 allows such changes to be identified from the transaction log using the powerful transaction log query functionality.

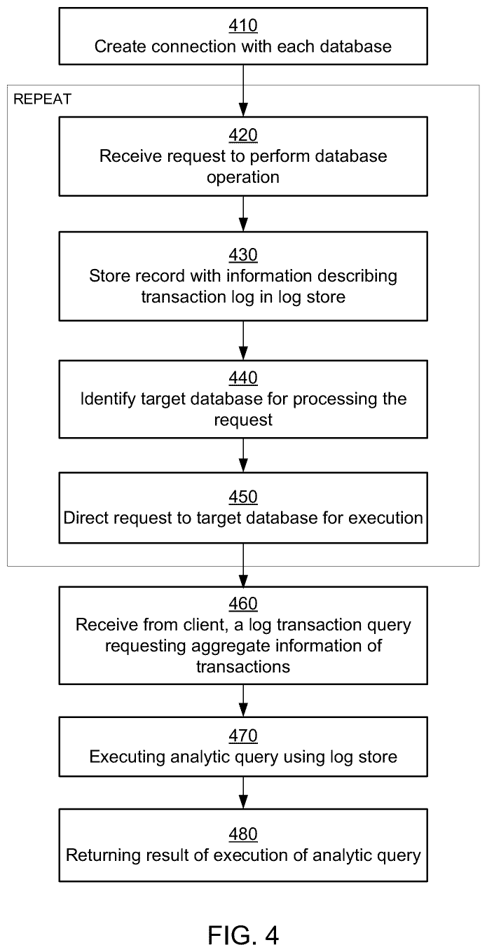

FIG. 4 is a flowchart illustrating the processing of transaction logs for supporting analytical queries based on transactions processed by the heterogeneous database system 100, according to an embodiment. The steps may be performed by the various modules of the heterogeneous database system 100, for example, the database middleware 150.

The database middleware 150 creates connections with each database 160 that stores the data processed by the heterogeneous database system 100. The database middleware 150 stores configuration information for each database 160 including the credentials for creating a connection. The database middleware 150 provides the credentials to each database 160 to login and create a connection. The database middleware 150 may maintain a connection pool for each database 160.

The database middleware 150 repeats the following steps 420, 430, 440, 450, multiple times. The database middleware 150 receives a request to perform a database operation, for example, an insert, update, delete request or a query. The request may be part of a sequence of requests that form a transaction. The database middleware 150 stores a record with information describing the transaction in the log store 265.

The database middleware 150 identifies 440 a target database for processing the request. The database middleware 150 directs 450 the request to the target database for execution.

The steps 420, 430, 440, 450 multiple times for different requests received by the heterogeneous database system 100. The database middleware 150 receives 460 a log transaction query requesting aggregate information of transactions. The transaction log store 265 may be a relational database and the transaction log query may be specified using a database query language such as SQL (structured query language.)

The transaction log query may specify a time range, such that the requested information need to be aggregated over all transactions processed during the time interval, independent of the database 160 on which the transaction was processed. The transaction log query may filter the set of transactions based on size of data or size of objects processed by the transaction. For example, the transaction log query may request an aggregate information for all transactions, or all database operations executed during a time interval that processed data or objects having size greater than a threshold values. The aggregation operation may be performed to determine a number of database operations or transactions that meet certain criteria, for example, database operations or transactions that were performed during certain time interval and/or database operations that processed data exceeding certain size threshold; or database operations performed over a subset of databases 160 during a time interval.

The result is aggregated across transactions executed over multiple databases 160. The transaction log query may request an aggregate value determined over a set of transactions or database operations executed over a subset of the plurality of database 160 connected to the database middleware 150. The subset of databases specified may include databases 160 having different architectures, for example, the subset of database specified in the transaction log query may include a key value store as well as a relational database. As another example, the subset of database specified in the transaction log query may include a document database as well as a relational database.

Since the database middleware 150 stores transaction data and metadata in the transaction log store 265, the database middleware 150 is able to execute the database query without sending an individual request to each of the subset of databases 160. The ability to processes transaction log queries without sending individual requests to the databases 160 results in improvement of efficiency of execution of the transaction log query. Furthermore, use of transaction log store 265 allows accessing the transaction log data without requiring conversions from each database 160 that mat store the transaction log data in a different format. Furthermore, individual database 160 may not store transaction logs for an extended period of time. For example, a database 160 may stores only recent transaction logs and delete older transaction logs. In contrast, the transaction log store 265 stores transaction log information over longer period of times compared to the individual database 160 in the backend. This allows the database middleware 150 to accurately process transaction lg queries that request historical data over long time intervals that include time intervals for which an individual database 160 has deleted the transaction logs.

Furthermore, since the transaction log store 265 stores transaction logs for extended periods of time, the transaction log data stored in the transaction log store 265 may be used to recover data of the database if there is need to re-execute data based on old transactions due to loss of data, for example, data loss caused by database failures such as fire or earthquakes.

The database middleware 150 executes the log transaction query using the transaction log store 265 of the database middleware 150. The database middleware 150 returns 480 the result of execution of the transaction query using the transaction log store 265.

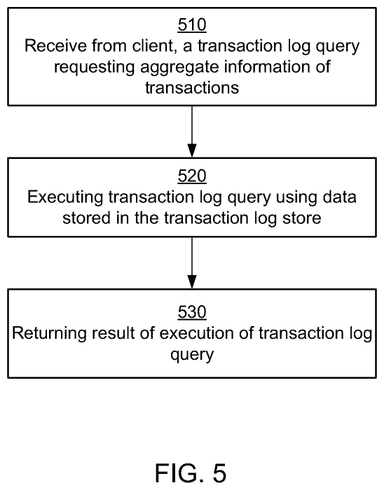

FIG. 5 is a flowchart illustrating the processing of transaction log queries by the heterogeneous database system 100, according to an embodiment. The steps may be performed by the various modules of the heterogeneous database system 100, for example, the database middleware 150.

The database middleware 150 receives 510 a transaction log query requesting information based on the data stored in transaction log store 265. The transaction log query may filter the transaction logs based on certain criteria, such as client application that sent the transaction requests, IP address of client devices that send the transaction requests, size of objects processed by the transactions, and so on. The transaction log query may process information across multiple transactions that may be executed by multiple backend databases 160. The transaction log query may aggregate information such as determining average size of objects processed by a set of transactions, average duration of transactions, relations between different types of transactions associated with the same record (e.g., whether two consecutive update operations were performed on the same record, whether a delete operation was performed within a threshold time of an insert or update operation, and so on. The database middleware 150 executes 520 the transaction log query using the data stored in the transaction log store 265. The database middleware 150 may return 530 the results of execution of the transaction log query for presentation via a user interface. Alternatively, the result of execution of the transaction log query may be used by database middleware 150 for various purposes, for example, to make a recommendation associated capacity panning of resources used by the heterogeneous database system 100 or to generate training data for training machine learning based models.

### Machine Learning Based System Resource Planning

The database middleware 150 supports machine learning based system resource planning, for example, for capacity and flow rate planning. The allows users such as DBAs to forecast specific value used for capacity/flow rate planning. The database middleware 150 executes transaction log queries for extracting various features based on transaction logs, for example, various aggregations based on transactions indicating patterns of transaction flow such as periodic (e.g., seasonal, daily, weekly, etc.) increases/decreases in transaction rates, changes in sizes of data processed by transactions, and so on. Such features are extracted from transaction logs storing historical data and used for training machine learning models such as neural networks. The transaction log queries also help extract features such as applications associated with the transactions, clients associated with the transactions, sizes of objects processed by the transaction, and so on. These features are provided as input to the machine learning based model. The machine learning model is configured to receive as input such features encoded as feature vector and predict output indicating capacity of specific resources such as storage resources, computing resources, and network resources. The machine learning model may be trained simply to predict transaction flow rate for a future time interval or for an expected change, for example change in a number of types of clients served by the system. The predicted transaction rate is further used for capacity planning by experts or using a second model.

FIG. 6 shows a flowchart illustrating the process of training a machine learning based model for predicting resource usage in a heterogeneous database system 100, according to an embodiment. The steps may be performed by the various modules of the heterogeneous database system 100, for example, the database middleware 150. The machine learning based model can be a neural network, for example, a multi-layered perceptron but is not limited to a specific architecture. For example, the machine learning based model can be any of support vector machine, neural network, Bayes classifies, linear regression model, decision tree-based model, and so on.

The database middleware 150 initializes 610 the parameters of a machine learning based model. The database middleware 150 stores a plurality of transaction log queries for extracting features from the transaction logs. The transaction log queries include parameters for example, to change the time intervals over which certain aggregation operation is performed. The database middleware 150 executes 620 the transaction log queries to extract features from transaction logs representing historical data and uses the results of the transaction lo queries as features for generating 630 training data for the machine learning based model.

According to an embodiment, the database middleware 150 receives information describing various events representing capacity adjustment events, for example, when storage of the system was increased, or network capacity was increased, or processing power was increased. The database middleware 150 identifies time intervals in the neighborhood of such events, for example, time intervals before the event occurrent, time intervals after the event occurred, time interval during which the event occurred. These time intervals are within a close proximity of the events, for example, each time interval has at least some portion within a threshold time of the event. The features extracted based on these time intervals are treated as positive training samples such that the information describing the event acts as the label for the training data. The labels assigned to each sample of data represent the expected output corresponding to the sample data. The database middleware 150 also identifies time intervals that are away from such events, i.e., they are more than a predefined threshold value away from such events. The transaction log queries are executed for those time intervals as negative samples for the training data.

The machine learning based model is trained 640 using the generated training data. The training process causes the weights of the machine learning model to be modified. Here, modifying the weights of machine learning based model comprises adjusting the weights to reduce a total measure of error between a predicted output and actual output. In an example embodiment, machine learning based model is trained using a backpropagation algorithm. In various embodiments, performing backpropagation comprises performing a gradient decent based on a cost function that defines how far a solution is from an optimal solution.

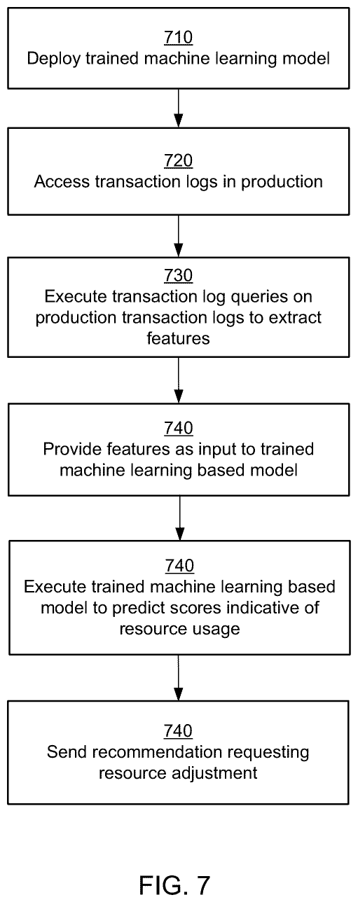

FIG. 7 shows a flowchart illustrating the process of deploying and executing the machine learning based model for predicting resource usage in a heterogeneous database system 100, according to an embodiment. The steps may be performed by the various modules of the heterogeneous database system 100, for example, the database middleware 150.

The database middleware 150 deploys 710 the trained machine learning based model. The database middleware 150 stores and accesses 720 the transaction logs from a recent time interval. The database middleware 150 executes 730 transaction log queries using the recent transaction logs to extract features received as input by the machine learning based model. The database middleware 150 executes 740 the trained machine learning based model to predict scores indicative of resource usage. The database middleware 150 may take an action based on the predicted resource usage, for example, by sending a recommendation requesting resource adjustment or automatically making a resource adjustment based on the identified recommendation.

### Object Size Based Hybrid Storage

In-memory database stores often put restrictions on the size of an object that can be stored in the database. Middleware provides the flexibility to adopt a hybrid approach where large objects can be stored on an S3 instance/Disk with a link to the same inserted into the in-memory or on-prem store, thus reducing the restrictions on object size. Users can focus on building solutions rather than on storage and operational aspects.

Furthermore, the database middleware 150 provides efficient and cost effective way of scaling data storage by seamlessly integrating different database technologies with the existing one. For example, a read intensive system, which deploys an in-memory key-value database to serve clients, can be scaled for larger data by plugging in on-disk key-value store, like RocksDb, alongside the in-memory store when it is not feasible to vertically scale the size of memory.

Middleware can be configured to distribute the data efficiently among underlying storages. Certain techniques that are employed for partitioning the data in a heterogeneous storage are: (1) Aging-data (2) Size-based data (3) User-based data (4) Frequently Used Data (5) Static & Dynamic Data.

The database middleware 150 routes and reads data/objects to/from the most appropriate data storage for the type or size of the data/object. The most appropriate data storage for a type of data/object is determined based on characteristics of the data/object or the characteristics of the transaction processing that data/object, and other factors, for example, access-pattern of the object, data-size of the object, desired query latency for queries processing the object, and cost of storage of the object.

According to an embodiment, the database middleware 150 stores a mapping from values or ranges of characteristics describing the objects or transactions to appropriate data storage systems. For example, the mapping may map ranges of sizes of data objects to data storage systems. For example, data objects that exceed certain threshold are stored in a particular data storage system and data objects that are below that threshold may be stored i another data storage system. Similarly, data objects associated with different values of query latencies may be stored in different data storage systems.

According to an embodiment, the database middleware 150 performs learning based on a reward metric. Accordingly, the database middleware 150 implements a reinforcement learning based mechanism to identify the ideal data storage system for various ranges of characteristics of objects/transactions. The reinforcement learning based model predicts whether a particular data storage system is suitable for certain characteristics of the objects/transactions. For example, the query latency value may be used as a reward metric. The system performs learning, for example, by mapping ranges of values of characteristics of objects or transactions to data storage systems and adjusting the ranges of values on a dynamic basis. For example, if a particular range of data sizes of object is assigned to a data storage system and over time the number of data objects in that range increases, thereby degrading the performance of the data storage system. Accordingly, the reward mechanism causes the range of the data sizes to be decreased so as to throttle the amount of data being sent to the data storage system. The initial assignment of data storage systems may be determined using an offline process. The system subsequently dynamically adjusts the assignments by monitoring the performance of the data storage system for various characteristics of the objects/transactions.

### Increased Storage Capacity

One the main concerns associated with in-memory databases in the size of data that can be held in memory. For example, the system may use an in-memory database as a backend that has storage limit of ˜400 GB. This imposes restrictions on users who want to expand but cannot expand because of capacity constraints. Users want to focus on solutions rather the operational and constraints of the system. Middleware solves this problem by making the storage technology pluggable. Accordingly, users can choose to use and experiment with different storage technologies that serves their purpose.

For example, RocksDB, an on-disk storage technology, has been proven to have high write throughput and comparable read throughput as that of TDMS. Since it is on-disk technology it can support multi-terabyte databases. Such as database can be used as a replacement for an im-memory database with small storage capacity. Similarly, any other storage technology that serves client's requirements can be plugged in with the Middleware.

### Long Term Transaction Logs Persistence System

For certain applications, such as trading, transaction logs serve as source of truth. Transactions Logs are sometimes kept for longer duration to meet the regulatory and audit requirement. Accordingly, decades old Transaction Logs may be required to be made available. During such long periods, the underlying databases 160 would have seen many software updates. Every software update could result in modifying the format in which transaction logs are persisted.

The transaction log interface of database middleware 150 can be leveraged to continue reading the transaction logs data stored in the legacy format. Additionally, the database middleware 150 allows use of a different storage technology (potentially distributed). This is powered by the database middleware's 150 ability to read multiple log format and perform a merge across those. This ability reduces the need of maintaining duplicative infrastructure for storing antiquated transaction logs.

As compared to key-value stores (non-relational stores), relational storages provide capability to run complex queries on the data. Hence the data is required to be streamed out from KV Store to a Relational Store. Using the database middleware's 150 transaction log interface, data can directly be stored in relational format alongside current serialized key value bytes, providing services like log readers to directly consume data from persistent log storage. This gives more flexibility on how and where to store the data thereby, expanding the horizon for using the data stored for many other purposes. For example, data analytics which is difficult with blobs of data stored as key value.

### Archives

Users run archive jobs periodically to move older trades, etc. to archives. Frequent archiving of data is required to keep the size of the active storage in check. Users frequently refer to archives to simulate trading strategies. This adds an overhead of mapping older trades to archives. Middleware can be used archive the data to a cold storage (i.e. On-Disk) while keeping latest data in operational storage (i.e. On-Cloud or On-Prem). Middleware can act as a single source of information of current and archived data and can reduce operational cost of periodic archival jobs.

### Database Unions

The heterogeneous database system 100 allows database unions to be performed efficiently. Clients use unions to back RW (read write) database with other databases having reference data. For example, A!B!C→where A is the front database, which can be RW (read write) or RO (read only) database. Databases B and C in the database union may be used as an RO Database. Reading data may perform multiple read operations, for example, read from database A if found, else read from database B if found, else read from database C. The system may perform multiple to-and-fro network communication between client and server if data is not found in one of the databases.

According to an embodiment, if a database operation requires multiple interactions with databases 160, the system sends details of the database operation, for example, the execution plan to the middleware. The database middleware 150 performs the multiple interactions with the databases 160 and returns the final result. An example, of such operation is database union. Other database operations such as join operations may also be performed in this manner. Thus the heterogeneous database system 100 avoids multiple calls between distant client and servers by pushing such complex processing to the database middleware 150.

### 24×7 Availability

The database middleware 150 with its decoupled design has made the task of achieving high availability easier. The decoupled design of middleware allows users to plugin a storage system which is distributed and guarantees high availability, for example FoundationDB. Any system cannot be truly available as long as it has single source of failure. Just having a distributed and highly available storage technology with single middleware will not help in achieving a truly 24*7 available system. Hence deploying a cluster of middleware with a distributed storage technology helps in achieving high availability. The database middleware 150 makes such adoption easy.

### Computing Machine Architecture

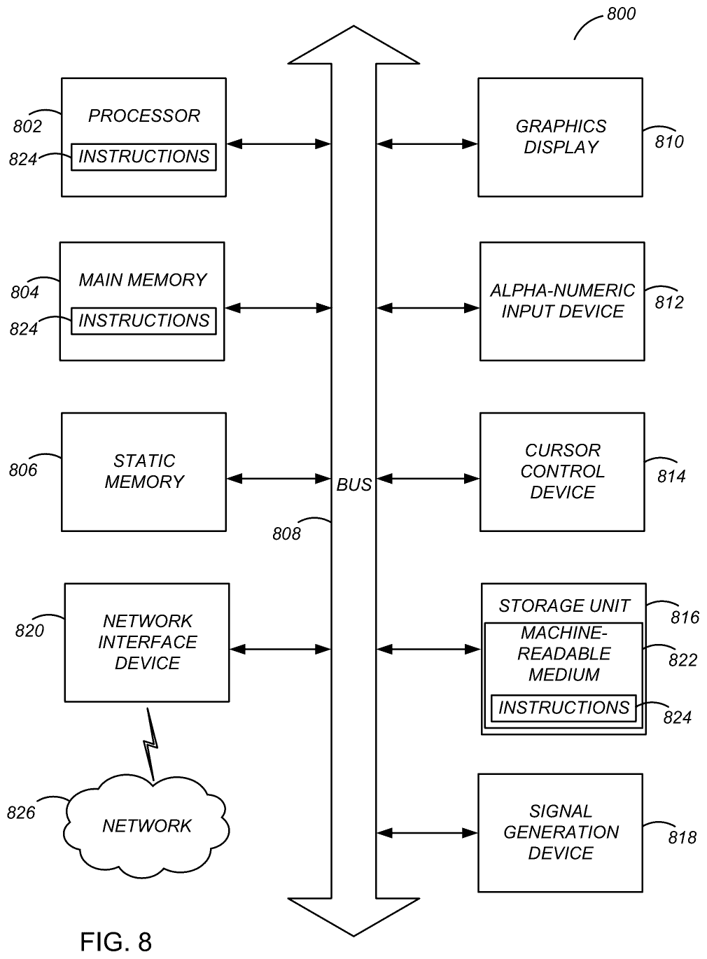

FIG. 8 is a block diagram illustrating components of an example machine able to read instructions from a machine-readable medium and execute them in a processor (or controller). Specifically, FIG. 8 shows a diagrammatic representation of a machine in the example form of a computer system 800 within which instructions 824 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 824 (sequential or otherwise) that specify actions to be taken by that machine. Further, while only a single machine is illustrated, the term “machine” shall also be taken to include any collection of machines that individually or jointly execute instructions 824 to perform any one or more of the methodologies discussed herein.

The example computer system 800 includes a processor 802 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 804, and a static memory 806, which are configured to communicate with each other via a bus 808. The computer system 800 may further include graphics display unit 810 (e.g., a plasma display panel (PDP), a liquid crystal display (LCD), a projector, or a cathode ray tube (CRT)). The computer system 800 may also include alphanumeric input device 812 (e.g., a keyboard), a cursor control device 814 (e.g., a mouse, a trackball, a joystick, a motion sensor, or other pointing instrument), a storage unit 816, a signal generation device 818 (e.g., a speaker), and a network interface device 820, which also are configured to communicate via the bus 808.

The storage unit 816 includes a machine-readable medium 822 on which is stored instructions 824 (e.g., software) embodying any one or more of the methodologies or functions described herein. The instructions 824 (e.g., software) may also reside, completely or at least partially, within the main memory 804 or within the processor 802 (e.g., within a processor's cache memory) during execution thereof by the computer system 800, the main memory 804 and the processor 802 also constituting machine-readable media. The instructions 824 (e.g., software) may be transmitted or received over a network 826 via the network interface device 820.

While machine-readable medium 822 is shown in an example embodiment to be a single medium, the term “machine-readable medium” should be taken to include a single medium or multiple media (e.g., a centralized or distributed database, or associated caches and servers) able to store instructions (e.g., instructions 824). The term “machine-readable medium” shall also be taken to include any medium that is capable of storing instructions (e.g., instructions 824) for execution by the machine and that cause the machine to perform any one or more of the methodologies disclosed herein. The term “machine-readable medium” includes, but not be limited to, data repositories in the form of solid-state memories, optical media, and magnetic media.

### Alternative Embodiments

It is to be understood that the figures and descriptions of the present invention have been simplified to illustrate elements that are relevant for a clear understanding of the present invention, while eliminating, for the purpose of clarity, many other elements found in a typical system. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for generating reports based on instrumented software through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for processing transaction log queries in a heterogeneous database system, the method comprising:
creating, by the heterogeneous database system, database connections with each of a plurality of databases, the plurality of databases comprising at least a relational database and a key-value store, the heterogeneous database system providing a particular database interface for interacting with each of the plurality of databases;
repeating, by a database middleware component of the heterogeneous database system at least a plurality of times:
receiving by the database middleware component, a request for a database operation from a client device, wherein the database operation is one of an insert operation, an update operation, or a delete operation;
storing, in a transaction log store, a record comprising information describing a transaction log for the database operation of the request;
identifying a target database from the plurality of databases for performing the database operation of the request; and
directing the request to the target database for execution;
receiving, by the heterogeneous database system a transaction log query aggregating information over a plurality of database operations performed by the heterogeneous database system, the plurality of database operations including database operations performed by the relational database and database operations performed by the key-value store;
executing by the database middleware component, the transaction log query using the transaction log store of the database middleware component; and
providing result of execution of the transaction log query based on the execution.

2. The method of claim 1, wherein the transaction log store is a relational database and the transaction log query is a database query specified in a database query language of the relational database.

3. The method of claim 1, further comprising:
monitoring performance of each of the plurality of databases for a plurality of requests processed by the heterogeneous database system; and
selecting the target database for directing the request for execution based on the monitored performance.

4. The method of claim 3, further comprising:
mapping characteristics of the database operations specified in the requests processed by the heterogeneous database system to performance of each of the plurality of databases; and
wherein selecting the target database for directing the request for execution based on the monitored performance comprises, determining characteristics of the request and selecting the target database based on the mapping.

5. The method of claim 4, wherein the characteristics of a particular request include size of data processed by the particular request such that requests processing data greater than a threshold size are directed to a particular database.

6. The method of claim 5, further comprising:
adjusting the threshold size based on monitoring of the performance of each of the plurality of databases for requests.

7. The method of claim 4, further comprising:
generating a map from values of a particular characteristic of requests to databases from the plurality of databases;
dynamically modifying the map based on changes in performance of the databases; and
directing requests to databases from the plurality of databases based on the modified map.

8. The method of claim 4, further comprising:
training a machine learning based model configured to receive as input, features describing requests processed by the heterogeneous database system and predicting resource requirements of the heterogeneous database system; and
executing the machine learning based model to predict resource requirements the heterogeneous database system.

9. A non-transitory computer readable storage medium storing instructions that when executed by one or more computer processors, cause the one or more computer processors to performs steps for processing transaction log queries in a heterogeneous database system, the steps comprising:
creating, by the heterogeneous database system, database connections with each of a plurality of databases, the heterogeneous database system providing a particular database interface for interacting with each of the plurality of databases;
repeating, by a database middleware component of the heterogeneous database system at least a plurality of times:
receiving by the database middleware component, a request for a database operation from a client device;
storing, in a transaction log store, a record comprising information describing a transaction log for the database operation of the request;
identifying a target database from the plurality of databases for performing the database operation of the request; and
directing the request to the target database for execution;
receiving, by the heterogeneous database system a transaction log query aggregating information over a plurality of database operations performed by the heterogeneous database system;
executing by the database middleware component, the transaction log query using the transaction log store of the database middleware component; and
providing result of execution of the transaction log query based on the execution.

10. The non-transitory computer readable storage medium of claim 9, wherein the transaction log store is a relational database and the transaction log query is a database query specified in a database query language of the relational database.

11. The non-transitory computer readable storage medium of claim 9, wherein the instructions further cause the one or more computer processors to perform steps comprising:
monitoring performance of each of the plurality of databases for a plurality of requests processed by the heterogeneous database system; and
selecting the target database for directing the request for execution based on the monitored performance.

12. The non-transitory computer readable storage medium of claim 11, wherein the instructions further cause the one or more computer processors to perform steps comprising:
mapping characteristics of the database operations specified in the requests processed by the heterogeneous database system to performance of each of the plurality of databases, wherein the characteristics of a particular request include size of data processed by the particular request such that requests processing data greater than a threshold size are directed to a particular database; and
wherein selecting the target database for directing the request for execution based on the monitored performance comprises, determining characteristics of the request and selecting the target database based on the mapping.

13. The non-transitory computer readable storage medium of claim 12, wherein the instructions further cause the one or more computer processors to perform steps comprising:
generating a map from values of a particular characteristic of requests to databases from the plurality of databases;
dynamically modifying the map based on changes in performance of the databases; and
directing requests to databases from the plurality of databases based on the modified map.

14. The non-transitory computer readable storage medium of claim 12, wherein the instructions further cause the one or more computer processors to perform steps comprising:
training a machine learning based model configured to receive as input, features describing requests processed by the heterogeneous database system and predicting resource requirements of the heterogeneous database system; and
executing the machine learning based model to predict resource requirements the heterogeneous database system.

15. A computer system comprising:
one or more computer processors; and
a non-transitory computer readable storage medium storing instructions that when executed by one or more computer processors, cause the one or more computer processors to performs steps comprising:
creating, by a heterogeneous database system, database connections with each of a plurality of databases, the heterogeneous database system providing a particular database interface for interacting with each of the plurality of databases;
repeating, by a database middleware component of the heterogeneous database system at least a plurality of times:
receiving by the database middleware component, a request for a database operation from a client device;
storing, in a transaction log store, a record comprising information describing a transaction log for the database operation of the request;
identifying a target database from the plurality of databases for performing the database operation of the request; and
directing the request to the target database for execution;
receiving, by the heterogeneous database system a transaction log query aggregating information over a plurality of database operations performed by the heterogeneous database system;
executing by the database middleware component, the transaction log query using the transaction log store of the database middleware component; and
providing result of execution of the transaction log query based on the execution.

16. The computer system of claim 15, wherein the transaction log store is a relational database and the transaction log query is a database query specified in a database query language of the relational database.

17. The computer system of claim 15, wherein the instructions further cause the one or more computer processors to perform steps comprising:
monitoring performance of each of the plurality of databases for a plurality of requests processed by the heterogeneous database system; and
selecting the target database for directing the request for execution based on the monitored performance.

18. The computer system of claim 17, wherein the instructions further cause the one or more computer processors to perform steps comprising:
mapping characteristics of the database operations specified in the requests processed by the heterogeneous database system to performance of each of the plurality of databases, wherein the characteristics of a particular request include size of data processed by the particular request such that requests processing data greater than a threshold size are directed to a particular database; and
wherein selecting the target database for directing the request for execution based on the monitored performance comprises, determining characteristics of the request and selecting the target database based on the mapping.

19. The computer system of claim 18, wherein the instructions further cause the one or more computer processors to perform steps comprising:
generating a map from values of a particular characteristic of requests to databases from the plurality of databases;
dynamically modifying the map based on changes in performance of the databases; and
directing requests to databases from the plurality of databases based on the modified map.

20. The computer system of claim 18, wherein the instructions further cause the one or more computer processors to perform steps comprising:
training a machine learning based model configured to receive as input, features describing requests processed by the heterogeneous database system and predicting resource requirements of the heterogeneous database system; and
executing the machine learning based model to predict resource requirements the heterogeneous database system.
